(19) United States
(12) Patent Application Publication
(10) Pub. No.: US 2024/0128628 A1
(43) Pub. Date: Apr. 18, 2024

(54) CHIP-TO-CHIP INTERFACE DEVICE COMPRISING WAVEGUIDE

(71) Applicant: GLS CO., LTD., Daejeon (KR)

(72) Inventors: Ki Dong SONG, Daejeon (KR); Ki Chan EUN, Daejeon (KR); Hye Min LEE, Seoul (KR); Won Ki JU, Seoul (KR)

(73) Assignee: GLS CO., LTD., Daejeon (KR)

(21) Appl. No.: 18/269,125

(22) PCT Filed: Dec. 24, 2020
(86) PCT No.: PCT/KR2020/019078

§ 371 Date: Jun. 22, 2023

(30) Foreign Application Priority Data
Dec. 23, 2020 (KR) 10-2020-0181878

(51) Int. Cl. H01P 3/14; H01P 3/08

(52) U.S. Cl. CPC H01P 3/14; H01P 3/081

(57) ABSTRACT

Proposed is a chip-to-chip interface device including a waveguide and, more particularly, a chip-to-chip interface device including a waveguide having the property of being flexible.

### TECHNICAL FIELD

The proposed technology relates to a chip-to-chip interface device including a waveguide and, more particularly, to a chip-to-chip interface device including a waveguide having the property of being flexible.

### BACKGROUND ART

As data traffic has increased rapidly, data transmission and reception speed of input/output buses (I/O buses) connecting integrated circuits (ICs) has also increased rapidly. Over the past few decades, a cost-efficient and power-efficient conductor-based interconnect (for example, copper wire) has been widely applied in wired communication systems.

However, the conductor-based interconnect has a fundamental limit on a channel bandwidth due to the skin effect caused by electromagnetic induction.

As an alternative to the conductor-based interconnect, an optical-based interconnect with fast data transmission and reception speeds has been introduced and is widely used, but the optical-based interconnect requires very high installation and maintenance costs, so it is difficult to completely replace the conductor-based interconnect.

In the meantime, millimeter waves (mm Guide) are extremely high frequency (EHF) waves with a wavelength of 1 to 10 mm and a frequency of 30 to 300 Ghz.

The high frequency of millimeter waves enables broadband transmission, and the short wavelength of millimeter waves enables antennas and transmission and reception devices to be manufactured in small size and light weight, and the frequency reuse rate is high.

However, due to strong straightness, millimeter waves are unsuitable for long-distance communication, but suitable for short-range communication for ultra-high-speed/high-capacity transmission and small communication device configuration because signal attenuation occurs frequently due to atmospheric factors and millimeter waves are greatly affected by geographical features, climates, and seasons.

In particular, the usage scenario targeted by 60-GHz WPAN communication is high-speed data transmission based on close proximity. This may be distinguished from near-field communication (NFC) technology, which defines communication at a distance of less than 10 cm, but has an incomparable advantage in transmission speed.

Therefore, there is a need to develop an interface device capable of ultra-high-speed short-range wireless communication using millimeter waves.

### SUMMARY OF THE DISCLOSURE

### Technical Problem

Accordingly, the present disclosure has been made keeping in mind the above problems occurring in the related art, and the present disclosure is directed to providing an interface device that is capable of ultra-high-speed short-range wireless communication using millimeter waves.

To this end, the present disclosure is directed to providing a waveguide having the property of being flexible.

### Technical Solution

According to an embodiment of the present disclosure, there is provided a chip-to-chip interface device including
a waveguide configured to transmit a signal from any one board to another board,
wherein the waveguide is formed in a shape of a flexible tube and
connects the boards by being bent therebetween.

The waveguide may be in a shape of a net formed of a plurality of meshes.

A plurality of the nets may overlap to form a plurality of layers.

When the plurality of the nets overlap to form the plurality of layers,
any two of the plurality of the nets may overlap in a particular area.

When the plurality of the nets overlap to form the plurality of layers,
mesh shapes of any two of the plurality of the nets may be different from each other.

The waveguide may be in a shape of a coil spring.

The waveguide may be in a shape of a corrugated tube that is elastic and composed of a plurality of ridges and grooves.

The waveguide may be a metal material.

Any one of the boards may include:
a transmission chip or a reception chip;
a waveguide transition having an antenna function, and configured to convert an electrical signal of the transmission chip into an electromagnetic signal and transmit the electromagnetic signal to the waveguide, or configured to convert an electromagnetic signal of the waveguide into an electrical signal and transmit the electrical signal to the reception chip; and
a connector configured to connect the board with the waveguide.

The waveguide transition may have a coplanar-waveguide-with-ground (CPWG) structure.

The waveguide transition may have a microstrip structure.

The transmission chip or the reception chip may be a 60-GHz communication module.

### Advantageous Effects

According to the present disclosure, the waveguide having the property of being flexible is provided to easily connect a transmitter with a receiver by being bent therebetween.

Therefore, the straightness of communication signals is not disrupted, and it is possible to solve a problem of increasing wave loss and signal disturbance due to scattering when the straightness is disrupted.

In addition, communication through free space can be achieved.

In addition, efficiency is high in terms of cost and power and high-speed short-range data communication is achieved.

### BRIEF DESCRIPTION OF THE DRAWINGS

FIG. 1 is a conceptual diagram of a chip-to-chip interface device to which a waveguide according to the present disclosure is applied.

FIG. 2 is a configuration diagram of a chip-to-chip interface device to which a waveguide according to the present disclosure is applied.

FIG. 3 is a first embodiment of a waveguide according to the present disclosure.

FIG. 4 is a second embodiment of a waveguide according to the present disclosure.

FIG. 5 is a third embodiment of a waveguide according to the present disclosure.

### BEST MODE FOR CARRYING OUT THE INVENTION

The above-described features and effects of the present disclosure will be more clearly understood from the following detailed description with reference to the accompanying drawings. Accordingly, those skilled in the art to which the present disclosure pertains can easily embody the technical idea of the present disclosure. The present disclosure may be modified in various ways and implemented by various embodiments, so that exemplary embodiments are shown in the drawings and will be described in detail. However, there is no intent to limit the present disclosure, and it is to be understood that the exemplary embodiments include all modifications, equivalents, or substitutes in the idea and the technical scope of the present disclosure. The terms used in the present application are merely used to describe the embodiments, and are not intended to limit the present disclosure.

Hereinafter, exemplary embodiments of the present disclosure will be described in detail with reference to the accompanying drawings.

The present disclosure relates to a chip-to-chip interface device including a waveguide and, more particularly, to a chip-to-chip interface device including a waveguide having the property of being flexible.

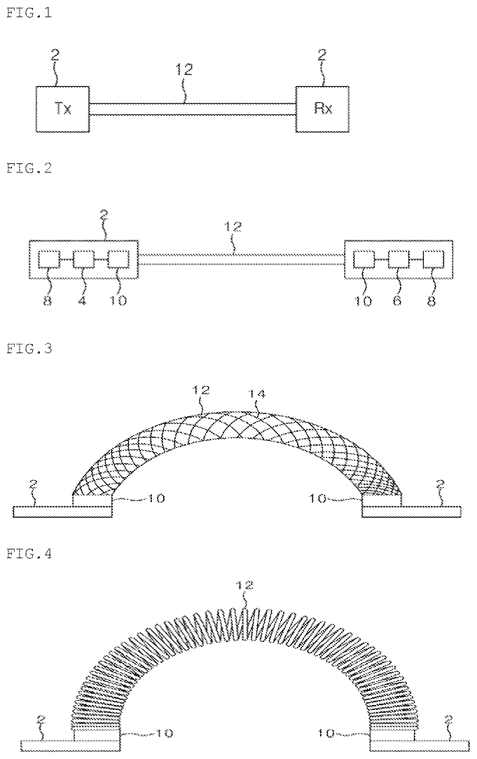

FIG. 1 shows a conceptual diagram of a chip-to-chip interface device to which a waveguide according to the present disclosure is applied. FIG. 2 shows a configuration diagram of a chip-to-chip interface device to which a waveguide according to the present disclosure is applied.

An interface device of the present disclosure includes a waveguide for connecting a chip to a chip or connecting a board to a board. The interface device includes a plurality of boards 2, and a waveguide 12 for connecting any one board 2 to another board 2 to transmit communication signals between the boards 2.

Each board 2 includes a transmission chip 4 or a reception chip 6. Any one of the plurality of boards 2 includes the transmission chip 4 and another board 2 includes the reception chip 6.

Alternatively, one board 2 may include both the transmission chip 4 and the reception chip 6. In this case, the waveguide 12 connects the transmission chip with the reception chip 6 to transmit communication signals between the chips.

The transmission chip 4 or the reception chip 6 may be a 60-GHz communication module, preferably, a V-band Zing-chip.

The transmission chip 4 may serve as a reception chip 6 when necessary, and the reception chip 6 may serve as a transmission chip 4 when necessary.

Each board 2 includes a waveguide transition 8 for changing and transmitting signals between the transmission chip 4 or the reception chip 6 and the waveguide 12.

The waveguide transition 8 includes an antenna function.

That is, electrical signals of the transmission chip 4 are converted into electromagnetic signals by the waveguide transition 8 connected to the transmission chip 4, and the electromagnetic signals resulting from conversion are transmitted to the waveguide 12 by an antenna of the waveguide transition 8.

The electromagnetic signals transmitted from the transmission chip 4 to the waveguide 12 are transmitted to an antenna of the waveguide transition 8 connected to the reception chip 6, and converted into electrical signals by the waveguide transition 8 of the reception chip 6, and the reception chip 6 receives the electrical signals.

The waveguide transition 8 may have a microstrip structure or a coplanar-waveguide-with-ground (CPWG) structure.

The coplanar-waveguide-with-ground (CPWG) structure is a combination of a microstrip structure and a coplanar waveguide (CPW) structure, and is a structure in which similarly to a microstrip structure, the ground is added to the underside of a CPW, which is a structure with no ground.

The coplanar-waveguide-with-ground (CPWG) structure configured as described above has a smaller characteristic impedance and a greater effective dielectric constant than a general CPW.

In particular, using the ground at the underside results in the characteristic that the change in impedance is less reduced even if W on the actual upper surface changes. Considering the characteristic in reverse, it means that even if there is an error or change in the guiding slot (W), the impedance stabilizes without much change.

The board 2 includes a connector 10 for physically and electrically connecting the board 2 with the waveguide 12.

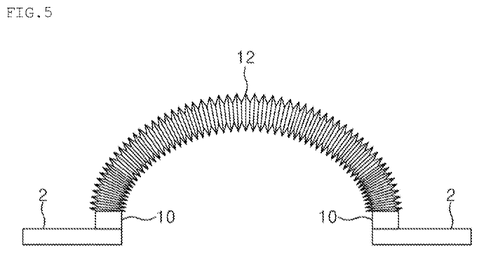

FIG. 3 shows a first embodiment of a waveguide according to the present disclosure. FIG. 4 shows a second embodiment of a waveguide according to the present disclosure. FIG. 5 shows a third embodiment of a waveguide according to the present disclosure.

The waveguide 12 is a V-tube formed in the shape of a flexible tube. The waveguide 12 connects any one board 2 to another board 2 by being bent therebetween. Alternatively, the waveguide 12 connects any one chip to another chip that are placed on one board 2 by being bent therebetween.

The waveguide 12 may be formed in the shape of a net formed of a plurality of meshes 14, as shown in FIG. 3.

When the waveguide 12 is formed in the shape of a net, the net may be formed in one layer, or a plurality of nets overlap each other and may be formed in a plurality of layers.

When the nets are formed to have a plurality of layers, any one net and another net, which overlap each other, are placed to overlap only in a particular area, not the entire area.

This is to enable the waveguide 12 formed of the plurality of nets to have a denser mesh structure.

In order for the waveguide 12 to have a denser mesh structure, a plurality of nets overlapping each other may be formed to have different shapes of meshes 14.

For example, any one net may be a net formed in the shape of a quadrangular mesh, and another net may be a net formed in the shape of a hexagonal mesh. The shapes of the meshes are not limited.

In this case, the waveguide 12 may be formed with a denser mesh structure.

When the waveguide 12 is formed in the shapes of the nets, the area of the meshes 14 is small or large depending on a distance between boards 2 or a distance between chips, thus adjusting the length of the waveguide 12.

The waveguide 12 may be formed in the shape of a coil spring, as shown in FIG. 4.

When the waveguide 12 is formed in the shape of a coil spring, the coil spring is stretched and returned, thus adjusting the length of the waveguide 12.

The waveguide 12 may be formed in the shape of a corrugated tube composed of a plurality of ridges and grooves, as shown in FIG. 5.

When the waveguide 12 is formed in the shape of a corrugated tube, the length of the waveguide 12 is adjusted by elasticity due to continuous corrugation composed of ridges and grooves.

The waveguide's 12 the property of being flexible may support connecting any ends at any positions in free space.

The waveguide 12 is made of a metal material to enable overall transceiver power consumption to be maintained regardless of the length of the waveguide 12.

In addition, signal interference from other channels and nearby waveguides 12 may be isolated.

The transmission chip 4 includes: a data collector for receiving command data from a controller of an apparatus to which the boards are applied, wherein the command data is related to operation control of the transmission chip 4; a communication chip controller for transmitting the command data received from the data collector to a transmission module; and the transmission module for transmitting an electrical signal according to the command data.

The transmission module includes: an oscillator (VCO) 45 for generating an ultra-high-frequency electromagnetic wave signal; a modulator 46 for performing modulation on the signal generated by the oscillator; an amplifier (PA) for amplifying the modulated ultra-high-frequency electromagnetic wave signal received from the modulator; and an antenna for transmitting the amplified ultra-high-frequency electromagnetic wave signal.

The oscillator generates a signal in the 60 GHz band.

The modulator performs demodulation or onoff keying (OOK) modulation.

The amplifier follows a capacitance-neutralized method.

The reception chip 6 includes: a receiver (detector) for receiving an electrical signal transmitted from the waveguide; an amplifier (LNA) 47 for amplifying the electrical signal to minimize noise; and a limiter for removing the noise.

The transmission chip 4 and the reception chip 6 may include a modem that is a wireless communication module, and a SerDes for serializing data.

Although the present disclosure has been described with reference to the exemplary embodiments, those skilled in the art will appreciate that various modifications and variations can be made in the present disclosure without departing from the idea and the technical scope of the disclosure described in the appended claims.

1. A chip-to-chip interface device, comprising:
a waveguide configured to transmit a signal from any one board to another board,
wherein the waveguide is formed in a shape of a flexible tube and connects the boards by being bent therebetween.

2. The chip-to-chip interface device of claim 1, wherein the waveguide is in a shape of a net formed of a plurality of meshes.

3. The chip-to-chip interface device of claim 2, wherein a plurality of the nets overlap to form a plurality of layers.

4. The chip-to-chip interface device of claim 3, wherein when the plurality of the nets overlap to form the plurality of layers, any two of the plurality of the nets overlap in a particular area.

5. The chip-to-chip interface device of claim 4, wherein when the plurality of the nets overlap to form the plurality of layers, mesh shapes of any two of the plurality of the nets are different from each other.

6. The chip-to-chip interface device of claim 1, wherein the waveguide is in a shape of a coil spring.

7. The chip-to-chip interface device of claim 1, wherein the waveguide is in a shape of a corrugated tube that is elastic and composed of a plurality of ridges and grooves.

8. The chip-to-chip interface device of claim 1, wherein the waveguide is a metal material.

9. The chip-to-chip interface device of claim 1, wherein any one of the boards comprises:
a transmission chip or a reception chip;
a waveguide transition having an antenna function, and configured to convert an electrical signal of the transmission chip into an electromagnetic signal and transmit the electromagnetic signal to the waveguide, or configured to convert an electromagnetic signal of the waveguide into an electrical signal and transmit the electrical signal to the reception chip; and
a connector configured to connect the board with the waveguide.

10. The chip-to-chip interface device of claim 9, wherein the waveguide transition has a coplanar-waveguide-with-ground (CPWG) structure.

11. The chip-to-chip interface device of claim 9, wherein the waveguide transition has a microstrip structure.

12. The chip-to-chip interface device of claim 9, wherein the transmission chip or the reception chip is a 60-GHz communication module.
